(19) United States
(12) Patent Application Publication
(10) Pub. No.: US 2016/0283965 A1
(43) Pub. Date: Sep. 29, 2016

(54) TARGETED LOYALTY

(71) Applicant: NCR Corporation, Duluth, GA (US)

(72) Inventors: Joseph Bradley Ellis, III, Marietta, GA (US); Charles Martin Rose, Alpharetta, GA (US)

(21) Appl. No.: 14/671,000

(22) Filed: Mar. 27, 2015

(51) Int. Cl. G06Q 30/02

(52) U.S. Cl. CPC G06Q 30/0226; G06Q 30/0261

(57) ABSTRACT

A customer defined in a targeted promotion is identified within a geographical area where the targeted promotion is valid. A price for a good associated with the targeted promotion is resolved. A retail location for a retailer having the good at the price within the geographical area is determined. The price for the good and the retail location are communicated to a customer device of the customer when the customer is within the geographical area.

### BACKGROUND

Technology has been advancing in recent years at alarming rates. Perhaps, the most amazing aspect of technology advancement is the ease with which new technologies are now integrated into and adopted by industry and society in general.

Retailers and manufactures of products are attempting to learn as much as they can through these new technologies to compete for consumer business. Thus, information is being captured about individual consumers and categories of consumers that behave similarly. The information is used by the retailers to garner consumer loyalty as well.

As a result, consumers are typically offered a variety of electronic-based and print-based discounts for the purchase of products or groups of products.

Consumers willingly provide information about themselves and by agreeing to enroll in retailer loyalty plans. Most consumers have loyalty accounts with nearly every retailer they interact with. It is not uncommon to witness consumers during any given transaction fumbling through their things looking for a loyalty card to complete transactions. As a result, retailers have amassed a great deal of information about their consumers.

One goal of a retailer is to use the loyalty information that they have about their consumers to drive traffic at the retailer's stores. This can be particular useful when traffic is low at a store. Moreover, when a retailer is able to increase consumer traffic with an offer or a discount for one product, once a consumer in the store chances increase that the consumer will make additional purchases of other unrelated products. Thus, managing consumer traffic is critical to the highly competitive retail environment.

The challenge is to not only increase traffic but do it in such a way that it produces a profit for the retailer. That is, an unrealistic or costly offer may provide tremendous traffic but because the offer was so deeply discounted, the retailer may actually lose money even with increased purchases of other goods. No one knows product profit margins better than the retailers and, in particular, each retail store (since margins may vary from store to store for the same retailer). However, often store managers are at the mercy of their corporate headquarters and lack any significant control over local store offers, which is problematic because store managers usually know their consumers and their product offerings at great levels of granularity than their corporate headquarters.

### SUMMARY

In various embodiments, methods and a system for targeted loyalty offerings are presented.

According to an embodiment, a method for a targeted loyalty offering is provided. Specifically, a price for a good is obtained and a customer is identified to offer the price. Next, a customer device of the customer is notified of the price for the good that is to be made available to the customer at a retail location, which is within a predefined distance from a current customer location of the customer.

### BRIEF DESCRIPTION OF THE DRAWINGS

FIG. 1 is a diagram of a system for targeted loyalty offerings, according to an example embodiment.

FIG. 2 is a diagram of a method for a targeted loyalty offering, according to an example embodiment.

FIG. 3 is a diagram of another method for a targeted loyalty offering, according to an example embodiment.

FIG. 4 is a diagram of a targeted loyalty offering system, according to an example embodiment.

### DETAILED DESCRIPTION

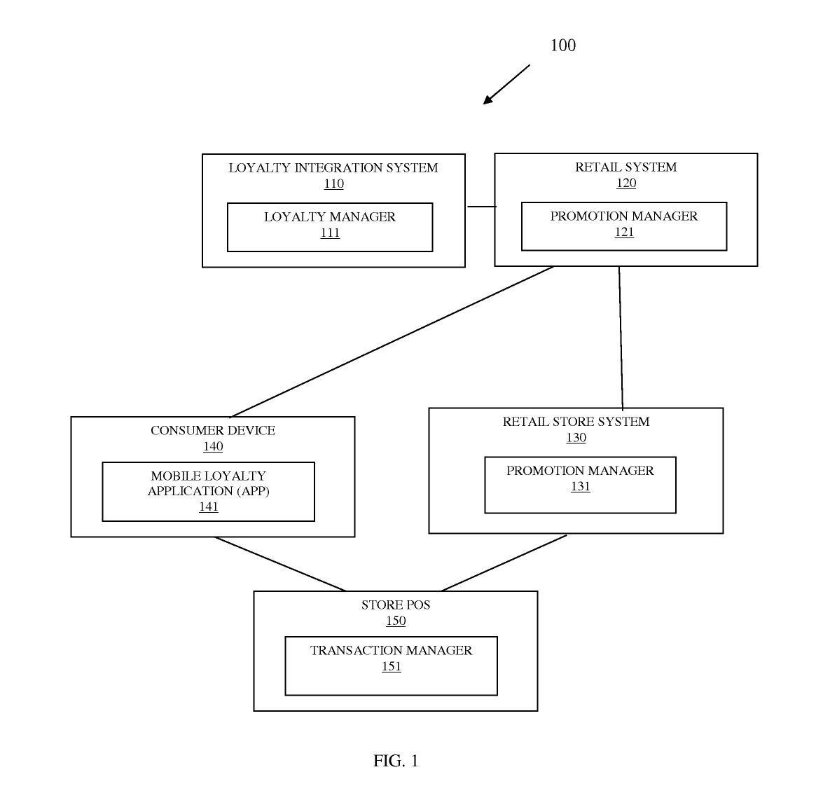

FIG. 1 is a diagram of a system 100 for targeted loyalty offerings, according to an example embodiment. The various components are illustrated and the arrangement of the components is presented for purposes of illustration only. It is to be noted that other arrangements with more or less components are possible without departing from the optimal promotional reward selection teachings presented herein and below.

The techniques and methods presented herein and below for targeted loyalty offering can be implemented in whole or in part in one, all, or some combination of the components shown with the system 100. The techniques and methods are programmed as executable instructions in memory and/or non-transitory computer-readable storage media and processed on one or more processors associated with the components.

As used here, the term “product,” “service,” and “good” may be used interchangeably to refer to something being purchased by a consumer from an enterprise. Moreover, the term “promotion” may be used interchangeably with the terms “offer,” “discount,” or “reward” to refer to something that provides a benefit to a consumer in some manner during a transaction. For example, the benefit may be increased reward points for the consumer, a free good with purchase of other goods, a discount purchase price on a good, and the like.

The term “consumer” may be used interchangeably with the terms “customer” and “user” and these terms refer to an entity that is engaged in a transaction with a retailer for which the techniques presented herein provide targeted loyalty offerings driving by a retail store.

It is within this context that the system 100 of the FIG. 1 is now discussed.

The system 100 includes a loyalty integration system 110 having a loyalty manager 111, a retail system 120 having a promotion manager 121, a retail store system 130 having a promotion manager 131, a consumer device 140 having a mobile loyalty application (app) 141, and a store Point-Of-Sale Terminal (POS) 150 having a transaction manager 151.

In an embodiment, the loyalty integration system 110 can manage a single retail system 120 and its loyalty accounts for customers.

In an embodiment, the loyalty integration system 110 can manage the retail system 120 and its loyalty accounts and a plurality of other different retailer systems and their loyalty accounts.

In an embodiment, the loyalty integration system 110 is an enhanced version of Advanced Marketing Solutions™ product offering distributed by NCR® Corporation of Duluth, Ga.

The loyalty integration system 110 provides end-user interfaces and Application Programming Interfaces (APIs) for querying, managing, and obtaining reporting regarding loyalty accounts for a retailer that operates retail stores. The loyalty integration system 110 interacts with the retail system 120 through a variety of software modules that process on both the loyalty integration system 110 and the retail system 120. A particular software module is the promotion manager 121, which interacts with the loyalty manager 111.

The promotion manager 121 interacts with a variety of other systems (not shown in the FIG. 1) for purposes of determining the price of goods and services offered by competitors and for purposes of determining the cost of acquire goods and services from manufacturers or dealers. These competitor prices and acquisition costs are made available in real time to the promotion manager 131 of the retail store system 130.

The retail store system 130 may be a separate device (desktop computer or server) from POS terminals within the retail store. Alternatively, the retail store system 130 may exists on one or each of the POS terminals within the retail store.

Promotions or offers distributed from the retail system 120 through the promotions manager 121 to a consumer device 140 of a consumer via the mobile loyalty app 141. The consumer can redeem the offers directly at a store POS terminal 150 when conducting a transaction, which is managed by a transaction manager 151. The store POS terminal 150 can be a Self-Service Terminal (SST) or a cashier-assisted terminal. The offer can be provided automatically from the consumer device 140 or can be manually entered by the consumer operating the consumer device 140 into a Human Input Device (HID) of the store POS 150. Automated communication mechanisms can include, by way of example only, Near Field Communication (NFC) data, WiFi, Bluetooth®, Radio Frequency (RF), a barcode presented to a scanner of the store POS 150, and/or a Quick Response (QR®) code presented to a scanner of the store POS 150.

In an embodiment, there is no actual promotion that needs redeemed by the consumer; rather, the consumer is notified of the promotion through the mobile loyalty app 141 and the consumer identifies himself/herself (credit card, loyalty identifier, phone number, etc.) for a transaction for which the promotion is available at the store POS 150. The transaction manager 151 then interacts with the promotion manager 131 to access a loyalty account for the consumer and the promotion (along with its restrictions) is identified and applied to the transaction. So, no actual promotion code or coupon needs to be presented by the consumer for the promotion to be ascertained and applied for the transaction.

In an embodiment, the promotion is identified as a price for a good; rather than as a discount off a current price for the good. So, as one example, rather than stating a fuel promotion as “10 cents per gallon of fuel purchased up to a maximum of 30 gallons at retail store X;” the fuel promotion is stated as “$2.00 per gallon of fuel purchased up to a maximum of 30 gallons at retail store X,” when the current price of fuel listed at retail store X is $2.10 per gallon.

During operation of the system 100 reports are generated from the retail system 120 detail customer traffic at the retail store associated with the retail store system 130. In addition, competitive pricing and acquisition costs for goods and services are generated as reports from the retail system 120. The traffic report data and the pricing and cost data can be fed to an analytics engine to make a decision on how to increase traffic at the retail store with a promotion for a given product (good or service) of the retail store.

Alternatively, the report data can be requested from a store manager of the retail store through the store system 130 using promotion manager 131 and the store manager makes a decision on how to increase traffic at the retail store with a promotion for a given product.

The promotion also includes a variety of restrictions defined by the discount for the product, the specific customer loyalty segment of customers for which the promotion can apply, a specific retail store or set of stores for which the promotion is redeemable, and a time frame during which the promotion is redeemable by the identified customers that can redeem the promotion.

The restrictions can be set automatically based on an automated decision made by the promotion manager 121 of the retail system 120 for the retail store and communicated through the promotion manager 131 of the store system 130.

Alternatively, the restrictions can be set by a store manager through interaction with an interface of the promotion manager 131 of the store system 130 and then communicated to the promotion manager 121 of the retail system 120 after the store manager reviews the report data or based on an independent decision made by the store manager even without having the benefit of reviewing the report data.

The promotion manager 131 then communicates the promotion directly to the targeted consumers by sending the promotion to the mobile loyalty apps 141 executing on the consumer devices 140.

A consumer desiring to redeem the promotion while at the retail store presents (automatically or manually as discussed above) the promotion during a transaction at the store POS 150. The promotion is received by the transaction manager 151 and verified through the store system 130 and the value of the promotion (discount) applied to the total transaction price for the transaction.

In an embodiment, the promotion is a fuel discount (such as a discount that reduces each gallon of fuel purchased by the consumer during a transaction) redeemed at a fuel pump (store POS 150) at a retail store while the consumer is purchasing fuel.

In an embodiment, the fuel discount is manually set through promotion managers 121 and/or 131 with a specific time frame for redemption (such as during a Grand Opening of the retail store, Happy Hour Fuel®, etc.). The promotion may also set a restriction for specific loyalty customers (such as via a fleet agreement with an enterprise for vehicles of that enterprise, Very Important Customers (VIP) based on loyalty level of class assignment, etc.). In some cases, the promotion may also set a restriction for a specific grade of fuel for which the promotion applies (such as diesel, a premium class, or regular unleaded).

In an embodiment, the fuel discount is determined dynamically and automatically using price points (pricing data) from within the retailer's owned and operated sites (stores). For example, customers are offered the lowest fuel price available within the retailer's chose sites in a single market. Data can be collected from the retail system 120 or the loyalty integration system 110 and the lowest price determined and pushed as an offer to the consumer. Price per unit of fuel is sent up to the retail system 120 or loyalty integration system 110 each time the loyalty offer is redeemed at a site (through transaction manager 151) or batch prices per unit can be set at predefined intervals or volume levels to be sent to the retail system 120 or loyalty integration system 110. In an embodiment, real time and batch reporting occurs to cross check for accuracy.

In an embodiment, the fuel discount is dynamically set using pricing data from a third-party vendor that aggregates prices for multiple fuel brands within a single market (Gas Buddy®, Fuel Quest®, etc.).

The dynamic targeted fuel discount (pricing) embodiments permit the lowest fuel price available to be dynamically made available to and dynamically communicated to customers of the retailer wherever those customers are physically located within a predefined area of those customers' present physical locations.

In an embodiment, threshold limits can be placed on the promotion such that once total volume levels are reached for the fuel promotion; the fuel promotion is dynamically terminated and communicated to the customers via those customers' consumer devices 140. In addition, threshold volume levels of fuel redemption can be placed on each promotion, such that the customer is limited on the fuel discount for up to a maximum number of gallons during a fuel purchase.

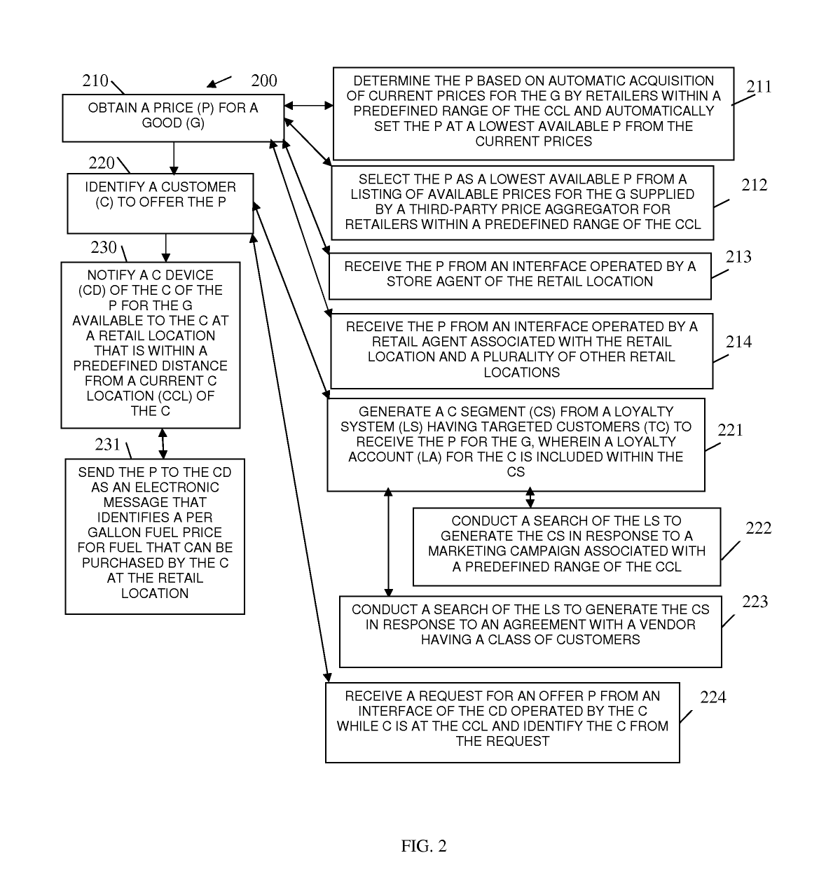

The above-discussed embodiments and other embodiments are now discussed with reference to the FIGS. 2-4.

FIG. 2 is a diagram of a method 200 for a targeted loyalty offering, according to an example embodiment. The software module(s) that implement the method 200 is referred to as a “targeted promotion manager.” Moreover, the executable instructions for the targeted promotion manager are programmed and residing within memory and/or a non-transitory computer-readable (processor-readable) storage medium and executed by one or more processors of a device. The processors are specifically configured and programmed to process the targeted promotion manager. The targeted promotion manager may have access to one or more networks. The networks are wired, wireless, or a combination of wired and wireless.

In an embodiment, the device that executes the targeted promotion manager is the retail system 120 of the FIG. 1.

In an embodiment, the device that executes the targeted promotion manager is the loyalty integration system 110 of the FIG. 1.

In an embodiment, the targeted promotion manager is the promotion manager 121 of the FIG. 1.

In an embodiment, the targeted promotion manager is the loyalty manager 111 of the FIG. 1.

In an embodiment, the targeted promotion manager is a combination of both the promotion manager 121 and the loyalty manager 111 of the FIG. 1.

At 210, the targeted promotion manager obtains a price for a good. Price acquisition can occur in a variety of automated and semi-automated manners.

For example, at 211, the targeted promotion manager determines the price based on automatic acquisition of current prices for the good by retailers within a predefined range of the current customer location and automatically setting the price at a lowest available price from the current prices. That is, the targeted promotion manager includes one or more external interfaces and/or APIs for querying and determining competitor prices for the good within the predefined range of the current customer location.

For various embodiments discussed herein and below, the current customer location can be resolved through a mobile loyalty application executing on the customer device; the application periodically reporting the current physical location of the customer device as resolved by one or more location resolving mechanisms of the customer device (such as Global Positioning Satellite (GPS), WiFi, etc.). In some cases, the customer can access either a mobile loyalty application or a web-based interface for the loyalty system and manually indicate the current customer location and/or the predefined range through a web interface of the loyalty system.

In another embodiment, at 212, the targeted promotion manager selects the price as a lowest available price from a listing of available prices for the good supplied by a third-party price aggregator for retailers within a predefined range of the current customer location. Again, an API or interface permits automated interaction with the third-party price aggregator by the targeted promotion manager for purposes of identifying the listing of available prices for the good within the predefined range.

In an embodiment, at 213, the targeted promotion manager receives the price from an interface operated by a store agent of the retail location. This is a scenario where the price is semi-automated because a store agent, such as a store manager of a retail store, resolves the price to set for the good and then communicates that price to the targeted promotion manager through the interface to the targeted promotion manager.

According to an embodiment, at 214, the targeted promotion manager receives the price from an interface operated by a retail agent associated with the retail location and a plurality of other retail locations. Here, a centralized agent associated with a chain of retail stores makes a decision regarding the price for the good at a particular retail store and sets that price by communicating that price through the interface to the targeted promotion manager.

At 220, the targeted promotion manager identifies a customer to offer the price for the good. Identification of the customer can occur in a variety of manners, some of which were discussed above with the discussion of the system 100 for the FIG. 1.

For example, at 221, the targeted promotion manager generates a customer segment from a loyalty system. The customer segment may be the result of a search of the loyalty system performed by an automated agent in response to retail metrics that trigger formulation of the search and execution of that search to produce the customer segment. In other cases, a marketing analyst or a store manager can conduct a search that generates the customer segment or define specific customers as belonging to the customer segment. The customer segment includes targeted customers that are to receive the price for the good. Moreover, a loyalty account for the customer is included within the customer segment.

In an embodiment of 221 and at 222, the targeted promotion manager conducts a search of the loyalty system in response to a marketing campaign associated with the predefined range of the customer's current location.

In another embodiment of 221 and at 223, the targeted promotion manager conducts a search of the loyalty system to generate the customer segment in response to an agreement with a vendor having a class of customers. For example, the retail store associated with the retail location may be a fuel purchase station; the agreement is for a fleet of school buses associated with the school transportation company, each operator of the school buses identified as a customer of the retail store in the loyalty system and being employed by the transportation company. The retail store has the agreement in place with the transportation company to provide the price (per gallon of fuel), such that the agreement defines a class of customers (the operators of the school buses) for which the price is given and the search generates a listing of all the operators as the customer segment.

In an embodiment, at 224, the targeted promotion manager receives a request for an offer price from an interface of the customer device operated by the customer while the customer is at the current customer location, such that the customer is identified from the request. For example, the customer accesses a mobile loyalty application executing on the customer's mobile phone or accesses a browser-based interface for the targeted promotion manager on the mobile phone and the customer requests a price per unit of fuel within the predefined area of the customer's current location. The mobile loyalty application interacts through an API with the targeted promotion manager and the customer can be identified either through login credentials supplied by the customer (or the mobile loyalty application on behalf of the customer) or through a mobile device identifier (mobile phone number) registered with the targeted promotion manager as belonging to the customer.

At 230, the targeted promotion manager notifies a customer device of the customer about the price for the good that is being offered by the targeted promotion manager. The price for the good is offered by the targeted promotion manager to the customer at a retail location that is within a predefined distance or range (geographical distance and/or range) from a current location of the customer (as determined by implication from the current physical location of the customer's device).

According to an embodiment, at 231, the targeted promotion manager sends the price to the customer's device as an electronic message that identifies a per gallon fuel price for fuel that can be purchased by the customer at the retail store defined by the retail location (physical location).

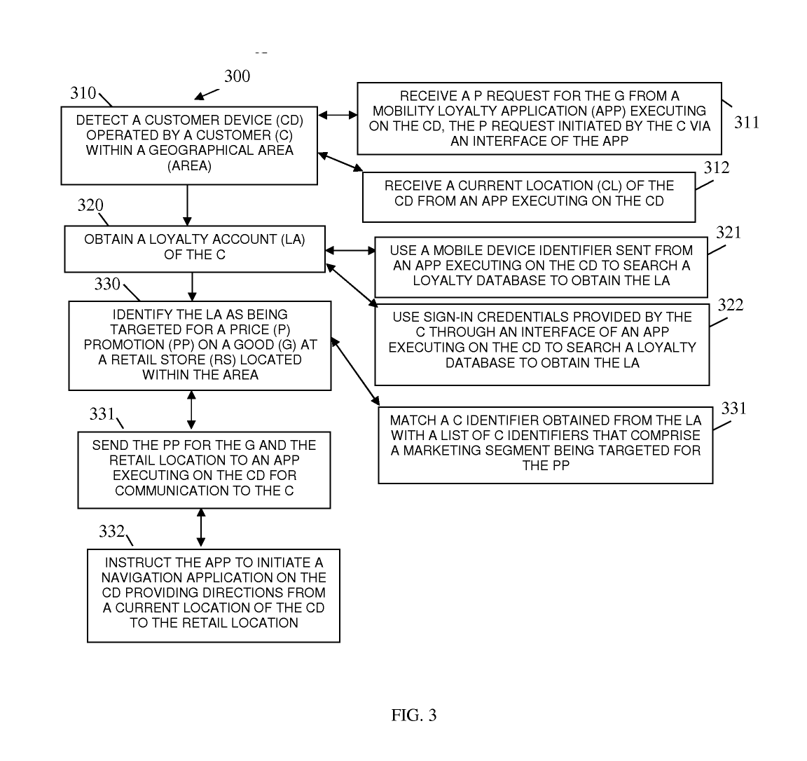

FIG. 3 is a diagram of another method 300 for a targeted loyalty offering, according to an example embodiment. The software module(s) that implement the method 300 is referred to as a “targeted offer manager.” The executable instructions of the targeted offer manager are implemented as instruction and programmed within memory and/or a non-transitory computer-readable (processor-readable) storage medium that executes on one or more processors of a device; the processors of the device are specifically configured to execute the targeted offer manager. The targeted offer manager may have access to one or more networks; the networks are wired, wireless, or a combination of wired and wireless.

In an embodiment, the targeted offer manager presents another and in some ways enhanced processing perspective to the targeted promotion manager presented above with the discussion of the method 200 of the FIG. 2.

In an embodiment, the device that executes the targeted offer manager is the loyalty integration system 110.

In an embodiment, the device that executes the targeted offer manager is the retail system 120.

In an embodiment, the device that executes the targeted offer manager is the retail store system 130.

In an embodiment, the device that executes targeted offer manager is the store POS 150.

In an embodiment, multiple devices cooperate over a network connection to execute the targeted offer manager. In an embodiment, the multiple devices include one or more combinations of: the loyalty integration system 110, the retail system 120, the retail store system 130, and the store POS 150.

In an embodiment, the device the device that executes the targeted offer manager is a POS terminal. In an embodiment, the POS terminal is a Self-Service Terminal (SST). In an embodiment, the POS terminal is a cashier-assisted terminal.

In an embodiment, the targeted offer manager is the promotion manager 121 of the FIG. 1.

In an embodiment, the targeted offer manager is the promotion manager 131 of the FIG. 1.

In an embodiment, the targeted offer manager is a combination of the promotion manager 121 and the promotion manager 131 of the FIG. 1.

At 310, the targeted offer manager detects a customer device operated by a customer within a geographical area. This can be an automated detection of the customer's device or a customer-initiated request made through an interface to the targeted offer manager that the customer is within the geographical area.

According to an embodiment, at 311, the targeted offer manager receives a request from the good from a mobile loyalty application executing on the customer's device. The price request is initiated by the customer via an interface of the mobile loyalty application that uses an API to communicate with the targeted offer manager.

In an embodiment, at 312, the targeted offer manager receives a current location of the customer's device from a mobile loyalty application executing on the customer's device. This embodiment is automated location reporting and requires no affirmative action by the customer for the targeted offer manager to become aware of the customer's current location within the geographical area.

At 320, the targeted offer manager obtains a loyalty account of the customer.

According to an embodiment, at 321, the targeted offer manager uses a mobile device identifier sent from a mobile loyalty application executing on the customer's device. The targeted offer manager uses the mobile device identifier to search a loyalty database to obtain the loyalty account associated with the customer.

In an embodiment, at 322, the targeted offer manager uses sign-in credentials provided by the customer through an interface of a mobile loyalty application executing on the customer's device to authenticate and search a loyalty database and obtain the loyalty account for the customer.

At 330, the targeted offer manager identifies the loyalty account as being targeted for a price promotion on a good at a retail store located within the geographical area (using a customer identifier for the customer; the customer identifier for the customer is also included in a list having the customer's identifier and other customer identifier's for other customers).

According to an embodiment, at 331, the targeted offer manager sends the price promotion for the good and the retail location to a mobile loyalty application executing on the customer's device for communication to the customer.

In an embodiment of 331 and at 332, the targeted offer manager instructs the mobile loyalty application on the customer's device to provide directions from a current location of the customer's device to the retail location.

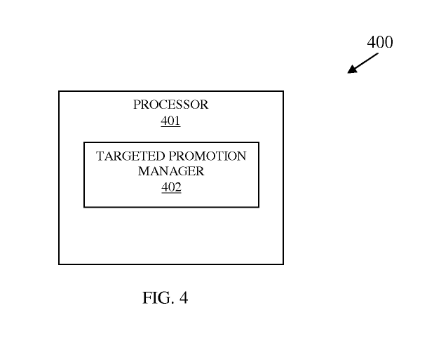

FIG. 4 is a diagram of a targeted loyalty offering system 400, according to an example embodiment. The components of the targeted loyalty offering system 400 are programmed and reside within memory and/or a non-transitory computer-readable medium and execute on one or more processors of one or more devices. The targeted loyalty offering system 400 may be operational over a network and the network can be wired, wireless, or a combination of wired and wireless.

In an embodiment, the targeted loyalty offering system 400 is the system 100 of the FIG. 1.

In an embodiment, the targeted loyalty offering system 400 implements, inter alia, the method 200 of the FIG. 2.

In an embodiment, the targeted loyalty offering system 400 implements, inter alia, the method 300 of the FIG. 3.

Thus, the description above with the FIGS. 1-3 are incorporated by reference herein with the description of the targeted loyalty offering system 400.

The targeted loyalty offering system 400 includes a processor 401 and a targeted promotion manager 402.

The targeted promotion manager 402 is configure to: execute on the processor 401, resolve a price for a good, manage a promotion associated with the good, dynamically identify a targeted customer within a geographical area for which the promotion is to be offered, and dynamically communicate the price for the good and a retail location for the good to a customer device of the customer when the customer device is within the geographical area.

In an embodiment, the price is a unit price for a gallon of fuel, the good is fuel, the retail location is a retail store providing the fuel at the price, and the customer device is selected from one of: a phone, a tablet, and a wearable processing device.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
obtaining a price for a good;
identifying a customer to offer the price; and
notifying a customer device of the customer of the price for the good available to the customer at a retail location that is within a predefined distance from a current customer location of the customer.

2. The method of claim 1, wherein obtaining further includes determining the price based on automatic acquisition of current prices for the good by retailers within a predefined range of the current customer location and automatically setting the price at a lowest available price from the current prices.

3. The method of claim 1, wherein obtaining further includes selecting the price as a lowest available price from a listing of available prices for the good supplied by a third-party price aggregator for retailers within a predefined range of the current customer location.

4. The method of claim 1, wherein obtaining further includes receiving the price from an interface operated by a store agent of the retail location.

5. The method of claim 1, wherein obtaining further includes receiving the price from an interface operated by a retail agent associated with the retail location and a plurality of other retail locations.

6. The method of claim 1, wherein identifying further includes generating a customer segment from a loyalty system having targeted customers to receive the price for the good, wherein a loyalty account for the customer is included within the customer segment.

7. The method of claim 6, wherein generating further includes conducting a search of the loyalty system to generate the customer segment in response to a marketing campaign associated with a predefined range of the current customer location.

8. The method of claim 6, wherein generating further includes conducting a search of the loyalty system to generate the customer segment in response to an agreement with a vendor having a class of customers.

9. The method of claim 1, wherein identifying further includes receiving a request for an offer price from an interface of the customer device operated by the customer while the customer is at the current customer location and identifying the customer from the request.

10. The method of claim 1, wherein notifying further includes sending the price to the customer device as an electronic message that identifies a per gallon fuel price for fuel that can be purchased by the customer at the retail location.

11. A method, comprising:
detecting a customer device operated by a customer within a geographical area;
obtaining a loyalty account of the customer;
identifying the loyalty account as being targeted for a price promotion on a good at a retail store located within the geographical area; and
communicating the price promotion and a location of the retail store to the customer device while the customer is within the geographical area.

12. The method of claim 11, wherein detecting further includes receiving a price request for the good from a mobile loyalty application executing on the customer device, the price request initiated by the customer via an interface of the mobile loyalty application.

13. The method of claim 11, wherein detecting further includes receiving a current location of the customer device from a mobile loyalty application executing on the customer device.

14. The method of claim 11, wherein obtaining further includes using a mobile device identifier sent from a mobile loyalty application executing on the customer device to search a loyalty database to obtain the loyalty account.

15. The method of claim 11, wherein obtaining further includes using sign-in credentials provided by the customer through an interface of a mobile loyalty application executing on the customer device to search a loyalty database to obtain the loyalty account.

16. The method of claim 11, wherein identifying further includes matching a customer identifier obtained from the loyalty account with a list of customer identifiers that comprise a marketing segment being targeted for the price promotion.

17. The method of claim 11, wherein communicating further includes sending the price promotion for the good and the retail location to a mobile loyalty application executing on the customer device for communication to the customer.

18. The method of claim 17, wherein sending further includes instructing the mobile loyalty application to initiate a navigation application on the customer device providing directions from a current location of the customer device to the retail location.

19. A system, comprising:
a processor; and
a targeted promotion manager configured to: i) execute on the processor, ii) resolve a price for a good, iii) manage a promotion associated with the good, iii) dynamically identify a targeted customer within a geographical area for which the promotion is to be offered, and iv) dynamically communicate the price for the good and a retail location for the good to a customer device of the customer when the customer device is within the geographical area.

20. The system of claim 19, wherein the price is a unit price for a gallon of fuel, the good is fuel, the retail location is a retail store providing fuel, and the customer device is one of: a phone, a tablet, and a wearable processing device.
